(19) United States
(12) Patent Application Publication
(10) Pub. No.: US 2010/0283249 A1
(43) Pub. Date: Nov. 11, 2010

(54) SYSTEM AND METHOD FOR CONVERSION OF OCEAN WAVES INTO USABLE MECHANICAL ENERGY

(76) Inventor: Phillip Harden, Cane Vale (BB)

Correspondence Address: BAY AREA INTELLECTUAL PROPERTY GROUP, LLC, PO BOX 210459, SAN FRANCISCO, CA, 94121-0459, US

(21) Appl. No.: 12/436,780

(22) Filed: May 7, 2009

(51) Int. Cl. F03B 13/14

(52) U.S. Cl. 290/53

(57) ABSTRACT

A system for conversion of ocean waves into usable mechanical energy includes at least one weight configured for movement along a linear path having a determined length where an orientation of an angle of the linear path with respect to gravitational forces is varied by forces of the ocean waves in a manner to cause the at least one weight to travel along the linear path due to the gravitational forces. At least one linkage translates the travel into the usable mechanical energy. The travel is in two directions and the at least one linkage translates the travel in the two directions into the usable mechanical energy. The at least one weight may include a water tank filled with water for operation of the system and may be emptied for transportation of the system. The usable mechanical energy can be used to operate an electric generator to produce electricity.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to wave motors. More particularly, the invention relates to a motor that uses the linear movement of a weight to convert random ocean waves into usable mechanical energy.

### BACKGROUND OF THE INVENTION

The vast majority of currently known wave motors or ocean energy generators fit into three categories: turbine, float and hydraulic. Turbine wave motor designs use the flow of water through a turbine to power a generator. Float wave motor designs use a float moving up and down with waves and tides to create hydraulic pressure or mechanical movement. In a prior art float generator, a generator coil reciprocates linearly in response to an external force acting on a float by passing ocean swells. A cable connects the float on the ocean surface with the reciprocating coil of the submerged generator. A magnetic field is focused through the coil as it reciprocates, creating an electromotive force in the coil. The generator includes a base formed on the ocean floor supporting a magnetic core having a generator coil movably mounted therein and connected to the float with a cable passing through cable alignment bearings.

The ocean is a very rough environment that can easily destroy turbines, floats and fixed power plants. The currently known wave motors previously described are in direct contact with water from the ocean and are therefore exposed to the elements of the ocean. A wave motor using means other than the direct force of or direct contact with ocean waves would be more protected from these elements.

In a prior art motor not using the direct force of or direct contact with ocean waves, electrical generators are operatively connected to rotating shafts for producing electrical energy from the mechanical rotative energy of the shafts as the tank tilts from side to side with the wave motion. Each gravity wheel in the motor is equipped with a ratchet-like lock that prevents backward motion. However, this motor only works in one direction and requires a purpose built housing, and therefore, cannot be placed in any existing floating structure.

In view of the foregoing, there is a need for improved techniques for providing means for converting ocean waves into mechanical energy that does not have direct contact with ocean waves and can easily be placed in existing floating structures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary gravity wave motor with a single generator using a belt drive type drive assembly, in accordance with an embodiment of the present invention;

FIG. 2 illustrates an exemplary small portable wave generator, in accordance with an embodiment of the present invention;

FIG. 3 illustrates an exemplary floating electrical plant, in accordance with an embodiment of the present invention;

FIG. 4 illustrates an exemplary gravity wave motor using a rocker arm type drive assembly;

FIG. 5 illustrates an exemplary wave motor 500, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, system for conversion of ocean waves into usable mechanical energy is presented.

In one embodiment, a system for conversion of ocean waves into usable mechanical energy is presented. The system includes at least one weight configured for movement along a linear path having a determined length where an orientation of an angle of the linear path with respect to gravitational forces is varied by forces of the ocean waves in a manner to cause the at least one weight to travel along the linear path due to the gravitational forces. At least one linkage translates the travel into the usable mechanical energy. In another embodiment the travel is in two directions and the at least one linkage translates the travel in the two directions into the usable mechanical energy. In another embodiment the at least one weight includes a water tank filled with water for operation of the system and may be emptied for transportation of the system. Other embodiments further include an electric generator where the usable mechanical energy is used to operate the electric generator to produce electricity and a gearbox for converting a high torque of the usable mechanical energy into a high speed lower torque for operating the electric generator. Still another embodiment further includes a flywheel joined to the electric generator for generating momentum from the usable mechanical energy to operate the electric generator. Yet other embodiments further include a housing for protecting components of the system from a water environment and the housing is configurable for installation in or on a floating platform. In another embodiment the determined length is at least in part determined by an anticipated frequency and height of the ocean waves. Another embodiment further includes bumpers at proximate ends of the linear path. Still another embodiment further includes a structure for joining at least the water tank and the electric generator where the at least one weight includes the structure. Yet another embodiment further includes at least a first wheel and a second wheel upon which the structure travels the linear path, a first linkage joined to the first wheel for translating the travel into usable mechanical energy when the structure travels in a first direction and a second linkage joined to the second wheel for translating the travel into usable mechanical energy when the structure travels in a second direction. Still another embodiment further includes a first electrical generator for generating electricity from the usable mechanical energy during travel in a first direction and a second electrical generator for generating electricity from the usable mechanical energy during travel in a second direction. In yet another embodiment the at least one linkage includes a pump producing a pressure and the pressure operates the electric generator.

In another embodiment a system for conversion of ocean waves into usable mechanical energy is presented. The system includes means for configuring at least one weight for traveling along a linear path in response to forces of the ocean waves and means for translating the traveling into the usable mechanical energy. Another embodiment further includes means for generating electricity from the usable mechanical energy. Yet another embodiment further includes means for protecting components of the system.

In another embodiment a method for conversion of ocean waves into usable mechanical energy is presented. The method includes the step of configuring at least one weight for movement along a linear path having a determined length where an orientation of an angle of the linear path with respect to gravitational forces is varied by forces of the ocean waves in a manner to cause the at least one weight to travel along the linear path due to the gravitational forces wherein the travel is in two directions. The method further includes the step of translating the travel in the two directions into the usable mechanical energy. Another embodiment further includes the step of using the usable mechanical energy to produce electricity. Yet another embodiment further includes the step of protecting components from a water environment.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention provide wave motor systems that use the linear back and forth movement of a weight such as, but not limited to, a water tank or similar heavy weight, by ocean waves to convert the random ocean waves into usable mechanical or kinetic energy rather than using waves or tides to raise a float or rotate a turbine as in many prior art methods. For example, without limitation, the weights in preferred embodiments move in the direction of gravity and the power generated is determined by the amount of weight vs. the height of the seas. Preferred embodiments generally have no direct contact with ocean water and are therefore better protected from the elements than prior art wave motors.

Since the force of the ocean is great enough to toss boats and ships weighing several tons each up and down like toys, preferred embodiments of the present invention harvest energy produced by the movement of weight because this movement of weight and therefore the available energy can be astounding. Preferred embodiments use the weight of water to harvest energy from the weight and force of water in a wave. This method is far cheaper, more powerful and more effective than currently known forms of alternative clean energy. Preferred embodiments also comprise a mechanical and/or hydraulic power train design that can produce power when moving back and forth in response to the rise and fall of ocean waves.

Preferred embodiments of the present invention use the rise and fall of ocean waves to move a weight, resulting in a linear back and forth movement that can be used to create usable mechanical energy. This energy may be calculated as follows:

PE=W×D,

where:

PE=the total potential energy of the object in ft-lb,

W=the total weight of the object in pounds, and

D=distance between the earth and the object in feet.

Mechanical kinetic energy is also measured in ft-lb. The amount of kinetic energy present at any one time is directly related to the velocity of the moving object and to the weight of the moving object.

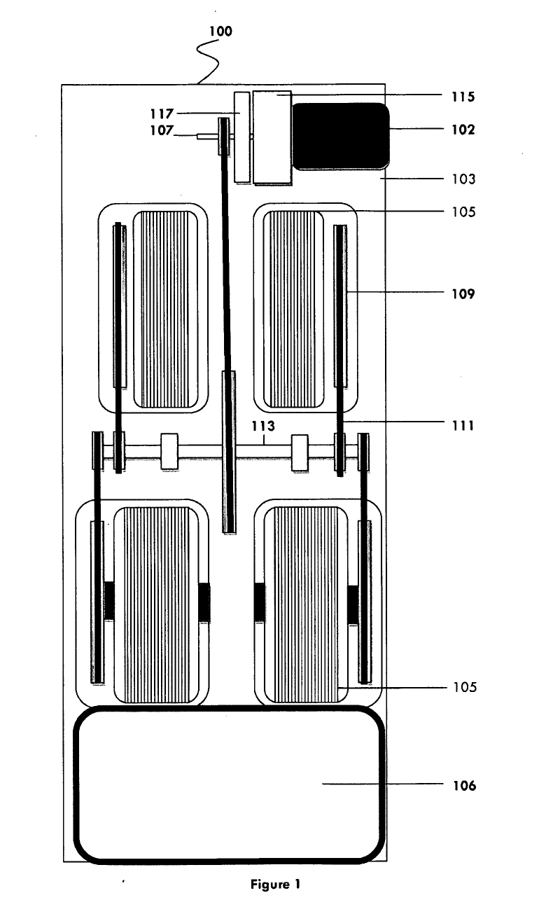

FIG. 1 illustrates an exemplary gravity wave motor 100 with a single generator 102, in accordance with an embodiment of the present invention. In the present embodiment, wave motor 100 is on a platform 103 with wheels 105 that enable wave motor 100 to roll forward and backward. In alternate embodiments, the linear movement of the wave motor can be achieved using various different means including, but not limited to, bearings or a track. In the present embodiment, the use of linearly moving platform 103 provides a relatively simple drive train and mechanics while also adding to the potential power of wave motor 100 since placing wave motor 100 on wheels 105 enables the entire weight of wave motor 100 including, but not limited to, the weight of generator 102 to become part of the power source for generator 102. A weight 106 increases the torque applied to a drive shaft 107. Wheels 105 and platform 103 may also be weighted to further increase the torque applied to drive shaft 107. In the present embodiment, wheels 105 are connected to pulleys 109 and 111 that are on ratchets. Pulleys 109 are on clockwise ratchets, and pulleys 111 are on counterclockwise ratchets. Pulleys 109 and 111 are then connected to a crankshaft 113, which is connected to drive shaft 107 and generator 102. Depending on various factors such as, but not limited to, the type of generator and the intended application, the electricity generated by wave motor 100 may be AC or DC. In alternate embodiments, the mechanical energy can be used for purposes other than generating electricity such as, but not limited to, producing compressed air, performing mechanical work, etc.

In typical use of the present embodiment, fluctuations in the surface of the ocean cause wave motor 100 to roll back and forth in a linear motion. In an alternate embodiment, the weight may move like a pendulum, swinging back and forth. In another alternative embodiment the weight rolls or slides around a fixed point rather than linearly. In the present embodiment, as wave motor 100 rolls back and forth, wheels 105 apply power to a highly geared gearbox 115, which multiplies the high torque of wheels 105 into high-speed, lower torque energy, converting the linear movement of wave motor 100 to mechanical rotational power to drive electrical generator 102. The ratchets on pulleys 109 and 111 enable wheels 105 to apply power to gearbox 115 when travelling in both a forward and backward direction. The gearing is similar to a bicycle whose pedals rotate freely backwards but will apply power when “pedaled” in a forward direction. By using this approach and using alternately placed “powered” ie. “pedaled” wheels, the alternate wheels roll freely in one direction and apply power in the other. Therefore, wheels 105 connected to pulleys 109 power generator 102 in one direction while wheels 105 connected to pulleys 111 power generator 102 when moving in the other direction. In alternate embodiments, applying power in both directions may be accomplished by using two generators on a platform that rolls back and forth with the rise and fall of ocean waves. In the present embodiment, a flywheel 117 provides momentum and helps to maintain the rotational speed of drive shaft 107 between waves, and this rotational energy powers electrical generator 102. In alternate embodiments the drive train may comprise various components including, but not limited to, a series of pulleys, a gearbox, chains and sprockets, gears, or a generator capable of producing electricity when rotated in either direction, etc. Furthermore, the main drive in alternate embodiments, may use various different drive means such as, but not limited to, a locomotive rocker arm, a rocker arm, a drive wheel, a hydraulic piston, etc.

Those skilled in the art, in light of the present teachings, will readily recognize that weight 106 may be any kind of weight imaginable such as, but not limited to, concrete blocks, rocks, water, steel, etc. However, it is preferable that weight 106 is a tank of freely available sea water, as this enables a user to fill or weight the tank after wave motor 100 is in place. This generally reduces the potential cost of the wave motor and provides for easier deployment of wave motor 100.

Wave motors according to embodiments of the present invention may vary greatly in size; for example, without limitation, some embodiments may be small and portable while other embodiments may be the size of power plants. Furthermore, weights and generators in embodiments of the present invention can be used in series along a coastline for large energy needs or individually for smaller needs. However the embodiments of the present invention may be used anywhere there are waves whether deployed for a coastal application or perhaps to provide energy for offshore needs as in the case of an embodiment installed on a sea going vessel.

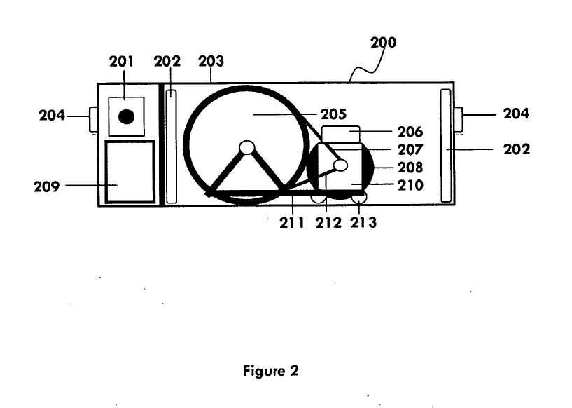

FIG. 2 illustrates an exemplary small portable wave generator 200, in accordance with an embodiment of the present invention. Wave generator 200 may be used to power boat lights, power a small electric boat motor, recharge marine batteries, etc. In the present embodiment, a waterproof box 203 protects wave generator 200 from the elements permitting wave generator 200 to be left in an open boat while anchored in the bay.

A rolling weight 205 applies rotational power to a gearbox 210, a DC generator 208 and a regulator 206. As the DC generator 208 on wheels 212 and the rolling weight 205 joined by frame 211 roll back and forth inside the box 203 in response to the rise and fall of ocean waves, the waves cause the DC generator 208 on wheels 213 and the rolling weight 205 to roll back and forth between the bumper guards 202. The bumper guards help to prevent damage to the waterproof container 203 and the generator 208. The rolling weight 205 creates rotation power which is applied to DC generator 208 by the drive belt 212 and the gearbox 210. The ceaseless rocking of the boat moves weight 205 back and forth. This motion is converted to rotational energy by pulley in gearbox 210 to turn generator 208 to generate electricity. The regulator 206 regulates the voltage output of generator 208. This electricity may then be used for various purposes including, but not limited to, charging a marine battery 209 or powering a device plugged into a 12V outlet 201. In the present embodiment, wave generator 200 also comprises handles 204 for ease of portability; however, alternate embodiments may not comprise handles.

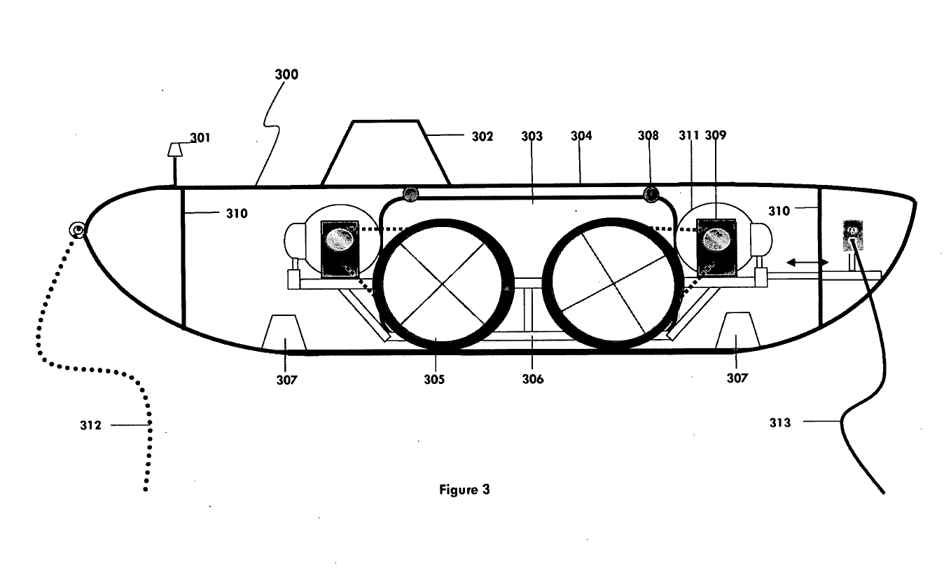

FIG. 3 illustrates an exemplary floating electrical plant 300, in accordance with an embodiment of the present invention. In the present embodiment, platform 306, supporting a large water tank 303 is on wheels 305. As the platform 306 rolls back and forth, in response to sea waves, the wheels 305 provide the rotational energy needed to spin the drive gears. The high torque but low speed of the drive gears is converted to higher speed rotational energy by gearboxes 309 needed to power generators 311 to generate electricity. Flywheels (not shown) help to maintain shaft speed between waves. The present embodiment comprises two drives. The two drives work in reverse of each other, generating electricity whether water tank 303 is moving forward or backward. Water tank 303 offers an economical and ecological solution for weight to power the drive gears. For convenience of installation, water tank 303 can be filled with seawater once floating electrical plant 300 is anchored in position or as needed. In a non-limiting example, if a wave motor is installed on a boat, the water tank may be emptied while the boat is being driven and then refilled again when the boat is anchored. The empty water tank would require less power for the boat to reach its destination because it would be carrying less weight. A simple water pump may be used to fill or empty the tank as desired using sea water which has no cost and is convenient to use. However, in alternate embodiments, any heavily weighted platform on wheels, bearings or a track may be used as a weight.

In the present embodiment, electrical plant 300 is anchored close to shore with an anchor line 312. Electrical plant 300 is completely enclosed and water tight protecting the motor and generators 311 from the elements. As the frame 306 rolls back and forth on the drive wheels 305 in response to the rise and fall of the sea waves, the track wheels 308 prevent the frame 306 and the parts it contains from bouncing or otherwise moving in manner that could damage the hull 304. Bumper guards 307 help to control the back and forth movements of the rolling frame 306. In alternate embodiments, a variety of movement control mechanisms can be used to control the up and down, forward and back forces on the weighted tank 303. These control mechanisms include but are not limited to automatic braking, springs, hydraulic shock absorbers etc. The purpose of the control system is to ensure a smooth and controlled movement of weight in response to the powerful rise and fall of sea waves rather than a potentially violent or uncontrolled response that could damage the system. An electrical cable 313 also known as a submarine cable carries power from electrical plant 300 to the shore. The motor can power both AC and DC generators. In an alternate embodiment, batteries could also be charged on-board a vessel and then delivered to shore, eliminating the need for a submarine cable 313. Floating electrical plant 300 may be quite wide. Unlike a boat typically narrow and built for low resistance to glide easily on the water, the wave motor hull 304 is built for the purpose of rocking up and down easily in response to waves. The hull 304 is also designed to withstand rough seas and is reinforced beneath the drive wheels 305 to provide adequate support for the weighted tank 303 and the entire frame 306. The bulkheads 310 serve to increase the structural rigidity of the vessel, divide functional areas, and create watertight compartments that can maintain buoyancy in the case of a hull breach or other leak. The Service hatch 302 allows easy access into the hull for service and maintenance. The LED beacon 301 uses little power and is powered by an on-board battery charged by the generators. In the present embodiment the wave motor is installed inside hull 304. Alternative embodiments of the present invention can be installed in or on any suitable floating platform such as, but not limited to, a boat, a barge, a box or buoy for instance. This additional flexibility further reduces the cost and improves the convenience of the present embodiment. The frequency and height of the waves can help to determine the best length of the hull in any given location.

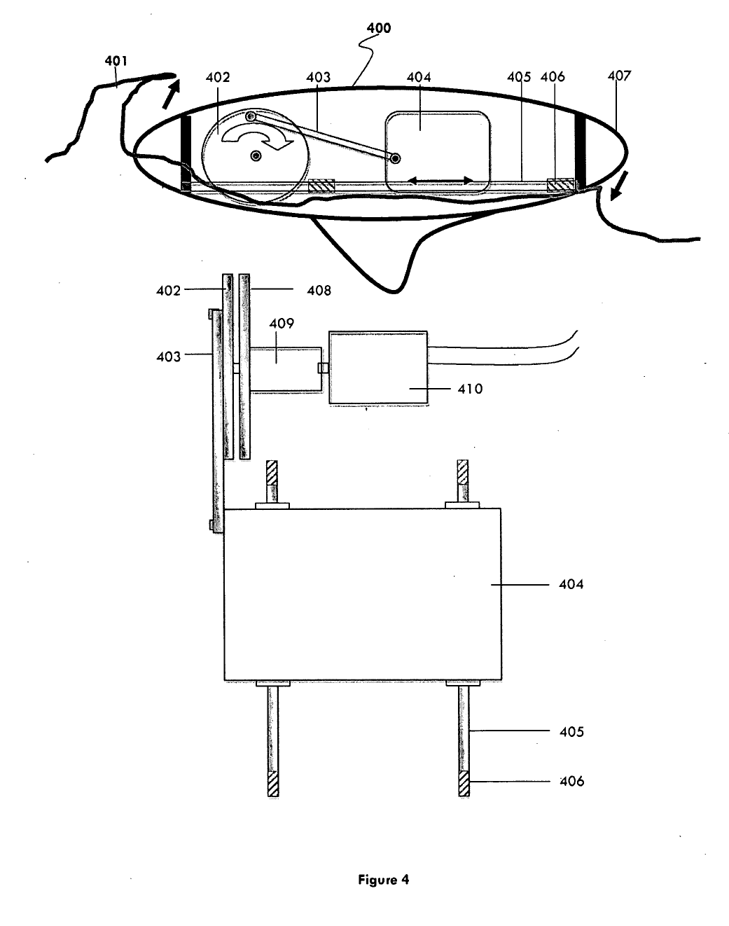

FIG. 4 illustrates an exemplary gravity wave motor using a rocker arm type drive assembly. In the present embodiment, wave motor 400 may be anchored, tethered to a floating platform or towed by a boat or ship. Wave motor 400 is completely enclosed within watertight hull 407. Wave 401 causes the hull 407 to rock up and down and the weight 404 to move back and forth along a linear track 405 between bumper guards 406. The back and forth movement of the weight 404 causes rocker arm 403 to rotate drive gear 402 which in turn rotates the flywheel 408 powering the generator 410 through gearbox 409. In alternative embodiments, wave motor 400 may be placed on a boat or ship or floating platform.

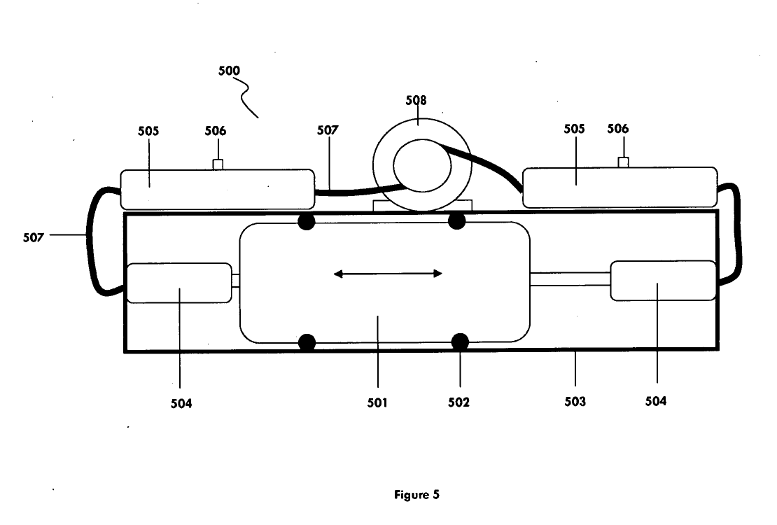

FIG. 5 illustrates an exemplary wave motor 500, in accordance with an embodiment of the present invention. In the present embodiment, wave motor 500 may be placed on a boat or ship or floating platform. As the weight 501 rolls back and forth on track wheels 502 in response to the rocking of the boat, the track wheels 502 control the movement of the weight within frame 503. The weight 501 can be a tank filled with water that can be filled and emptied as desired. As the weight 501 rolls back and forth it provides power to pumps 504 (either hydraulic or air pressure pumps) which in turn increase pressure in the pressure tank 505. The pressurized air or hydraulic fluid is carried through pressure hose 507 to provide power to generator 508. Pressure valve 506 acts as a safety valve to release pressure if and when necessary.

Having fully described at least one embodiment of the present invention, other equivalent or alternative methods of converting the linear motion of a weight moved by random waves into usable mechanical energy according to the present invention will be apparent to those skilled in the art. The invention has been described above by way of illustration, and the specific embodiments disclosed are not intended to limit the invention to the particular forms disclosed. For example, the particular implementation of the motor may vary depending upon the particular type of body of water in which the motor is used. The motors described in the foregoing were directed to implementations to be used in the ocean; however, similar techniques are to use wave motors in various different bodies of water such as, but not limited to, lakes, seas, ponds, rivers, etc. Implementations of the present invention for use in non-ocean settings are contemplated as within the scope of the present invention. The invention is thus to cover all modifications, equivalents, and alternatives falling within the spirit and scope of the following claims.

What is claimed is:

1. A system for conversion of ocean waves into usable mechanical energy, the system comprising:
at least one weight configured for movement along a linear path having a determined length where an orientation of an angle of said linear path with respect to gravitational forces is varied by the rise and fall of ocean waves in a manner to cause said at least one weight to travel along said linear path due to said gravitational forces; and
at least one linkage for translating said travel into the usable mechanical energy.

2. The system as recited in claim 1, wherein said travel is in two directions and said at least one linkage translates said travel in said two directions into the usable mechanical energy.

3. The system as recited in claim 1, wherein said at least one weight comprises a water tank filled with water for operation of the system and may be emptied for transportation of the system.

4. The system as recited in claim 1, further comprising an electric generator where the usable mechanical energy is used to operate said electric generator to produce electricity.

5. The system as recited in claim 4, further comprising a gearingsystem for converting a high torque of the usable mechanical energy into a high speed lower torque for operating said electric generator.

6. The system as recited in claim 4, further comprising an optional flywheel joined to said electric generator for generating momentum from the usable mechanical energy to operate said electric generator.

7. The system as recited in claim 4, further comprising a housing for protecting components of the system from a water environment.

8. The system as recited in claim 7, wherein said housing is configurable for installation in or on a floating platform.

9. The system as recited in claim 1, wherein said determined length is at least in part determined by an anticipated frequency and height of the ocean waves.

10. The system as recited in claim 7, further comprising bumpers, shock absorbers, springs, automatic braking, regenerative braking, hydraulic pistons, etc. at proximate ends of said linear path.

11. The system as recited in claim 4, further comprising a structure for joining at least said water tank and said electric generator where said at least one weight comprises said structure.

12. The system as recited in claim 11, further comprising at least a first wheel and a second wheel upon which said structure travels said linear path, a first linkage joined to said first wheel for translating said travel into usable mechanical energy when said structure travels in a first direction and a second linkage joined to said second wheel for translating said travel into usable mechanical energy when said structure travels in a second direction.

13. The system as recited in claim 1, further comprising a first electrical generator for generating electricity from the usable mechanical energy during travel in a first direction and a second electrical generator for generating electricity from the usable mechanical energy during travel in a second direction.

14. The system as recited in claim 1, wherein said at least one linkage comprises a pump producing a pressure and said pressure operates said electric generator.

15. A system for conversion of ocean waves into usable mechanical energy, the system comprising:
means for configuring at least one weight for traveling along a linear path in response to the rise and fall of ocean waves; and
means for translating said traveling into the usable mechanical energy.

16. The system as recited in claim 15, further comprising means for generating electricity from the usable mechanical energy.

17. The system as recited in claim 16, further comprising means for protecting components of the system.

18. A method for conversion of ocean waves into usable mechanical energy, the method comprising the steps of:
configuring at least one weight for movement along a linear path having a determined length where an orientation of an angle of said linear path with respect to gravitational forces is varied by forces of the ocean waves in a manner to cause said at least one weight to travel along said linear path due to said gravitational forces wherein said travel is in two directions; and
translating said travel in said two directions into the usable mechanical energy.

19. The method as recited in claim 18, further comprising the step of using the usable mechanical energy to produce electricity.

20. The method as recited in claim 19, further comprising the step of protecting components from a water environment.
